(19) United States
(12) Patent Application Publication
(10) Pub. No.: US 2022/0147825 A1
(43) Pub. Date: May 12, 2022

(54) MACHINE LEARNING

(71) Applicant: BRITISH TELECOMMUNICATIONS PUBLIC LIMITED COMPANY, LONDON (GB)

(72) Inventors: Gilbert OWUSU, London (GB); Hani HAGRAS, London (GB); Ravikiran CHIMATAPU, London (GB); Andrew STARKEY, London (GB)

(21) Appl. No.: 17/593,625

(22) PCT Filed: Mar. 18, 2020
(86) PCT No.: PCT/EP2020/057529

§ 371 Date: Sep. 21, 2021

(30) Foreign Application Priority Data
Mar. 23, 2019 (EP) 19164777.5

(51) Int. Cl. G06N 3/08; G06N 3/04

(52) U.S. Cl. CPC G06N 3/08; G06N 3/0436

(57) ABSTRACT

A computer implemented method for machine learning including training an autoencoder having a set of input units, a set of output units and at least one set of hidden units, wherein connections between each of the sets of units are provided by way of interval type-2 fuzzy logic systems each including one or more rules, and the fuzzy logic systems are trained using an optimization algorithm; and generating a representation of rules in each of the interval type-2 fuzzy logic systems triggered beyond a threshold by input data provided to the input units so as to indicate the rules involved in generating an output at the output units in response to the data provided to the input units.

### PRIORITY CLAIM

The present application is a National Phase entry of PCT Application No. PCT/EP2020/057529, filed Mar. 18, 2020, which claims priority from EP Patent Application No. 19164777.5, filed Mar. 23, 2019, each of which is hereby fully incorporated herein by reference.

### TECHNICAL FIELD

The present disclosure relates to machine learning. In particular it relates to explainable machine learning.

### BACKGROUND

The dramatic success of Deep Neural Networks (DNN) has led to an explosion of its applications. However, the effectiveness of DNNs can be limited by the inability to explain how the models arrived at their predictions.

### SUMMARY

According to a first aspect of the present disclosure, there is a provided a computer implemented method for machine learning comprising: training an autoencoder having a set of input units, a set of output units and at least one set of hidden units, wherein connections between each of the sets of units are provided by way of interval type-2 fuzzy logic systems each including one or more rules, and the fuzzy logic systems are trained using an optimization algorithm; and generating a representation of rules in each of the interval type-2 fuzzy logic systems triggered beyond a threshold by input data provided to the input units so as to indicate the rules involved in generating an output at the output units in response to the data provided to the input units.

In some embodiments, the optimization algorithm is a Big-Bang Big-Crunch algorithm.

In some embodiments, each type-2 fuzzy logic system is generated based on a type-1 fuzzy logic system adapted to include a degree of uncertainty to a membership function of the type-1 fuzzy logic system.

In some embodiments, the type-1 fuzzy logic system is trained using the Big-Bang Big-Crunch optimization algorithm.

In some embodiments, the representation is rendered for display as an explanation of an output of the machine learning method.

According to a second aspect of the present disclosure, there is a provided a computer system including a processor and memory storing computer program code for performing the steps of the method set out above.

According to a third aspect of the present disclosure, there is a provided a computer system including a processor and memory storing computer program code for performing the method set out above.

### BRIEF DESCRIPTION OF DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an Interval Type-2 Fuzzy Logic System (IT2FLS) 200 in accordance with embodiments of the present disclosure.

FIG. 3 illustrates membership for an Interval Type-2 Fuzzy Set according to an exemplary embodiment of the present disclosure.

FIG. 4 illustrates an architecture of a Multi-Layer Fuzzy Logic System (M-FLS) in accordance with embodiments of the present disclosure.

FIG. 5 illustrates a Multi-Layer Fuzzy Logic System in accordance with embodiments of the present disclosure.

FIGS. 6a and 6b depict visualizations of triggered rules for an input in a Multi Layer Fuzzy Logic System according to embodiments of the present disclosure.

FIG. 7 is a flowchart of a method for machine learning according to embodiments of the present disclosure.

### DETAILED DESCRIPTION

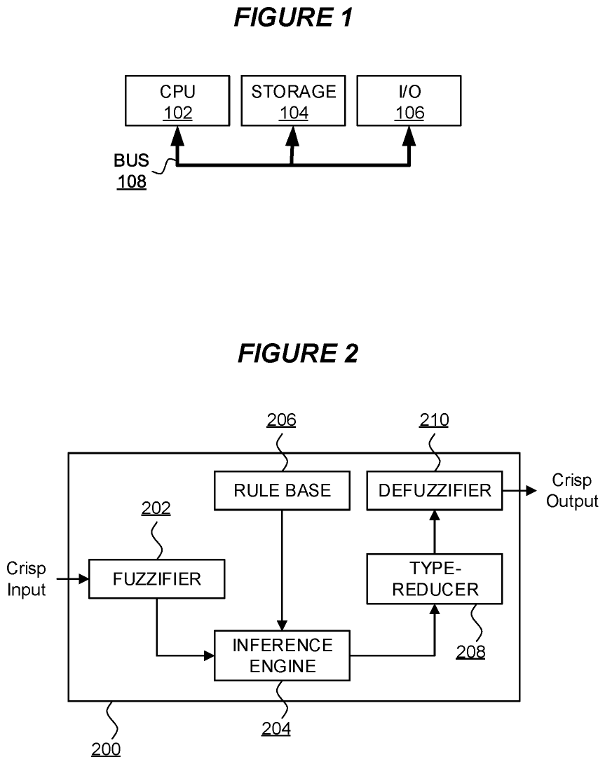

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Artificial Intelligence (AI) systems are being adopted very rapidly across many industries and fields such as robotics, financial, Insurance, healthcare, automotive, speech recognition etc., as there are huge incentives to use AI systems for business needs such as cost reductions, productivity improvements, risk management etc. However, the use of complex AI systems such as deep learning, random forests, and support vector machines (SVMs), could result in a lack of transparency in order to create “black/opaque box” models. These lack of transparency issues are not specific to deep learning, or complex models, there are other classifiers, such as kernel machines, linear or logistic regressions, or decision trees that can also become very difficult to interpret for high-dimensional inputs.

Hence, it is necessary to build trust in AI systems by moving towards “explainable AI” (XAI). XAI is a DARPA (Defense Advanced Research Projects Agency) project intended to enable “third-wave AI systems” in which machines understand context and environment in which they operate and, over time, build underlying explanatory models allowing them to characterize real world phenomena.

An example of why interpretability is important is the Husky vs. Wolf experiment (Marco Tulio Ribeiro, Sameer Singh, and Carlos Guestrin. 2016. “Why Should I Trust You?”: Explaining the Predictions of Any Classifier. In Proceedings of the 22nd ACM SIGKDD International Conference on Knowledge Discovery and Data Mining (KDD '16). ACM, New York, N.Y., USA, 1135-1144. DOI: https://doi.org/10.1145/2939672.2939778). In this experiment a neural network was trained to differentiate between dogs and wolfs. It did not learn the difference between them—instead it learned that wolves usually stand near snow and dogs usually stand on grass. It is especially necessary to provide a model for high dimensional inputs which provides better interpretability than existing black/opaque box models.

Deep Neural Networks have been applied in a variety of tasks such as time series prediction, classification, natural language processing, dimensionality reduction, speech enhancement etc. Deep learning algorithms use multiple layers to extract inherent features and use them to discover patterns in the data.

Embodiments of the present disclosure use an Interpretable Type 2 Multi-Layer Fuzzy Logic System which is trained using greedy layer wise training similar to the way Stacked Auto Encoders are trained (Y. Bengio, P. Lamblin, D. Popovici, and H. Larochelle, “Greedy layer-wise training of deep networks,” in Advances in neural information processing systems, 2007, pp. 153-160). Greedy layer wise training is used to learn important features or combine features. This allows a system to handle a much larger number of inputs when compared to standard Fuzzy Logic Systems. A further benefit is that it allows the system to be trained using unsupervised data.

FIG. 2 is a component diagram of an Interval Type-2 Fuzzy Logic System (IT2FLS) 200 in accordance with embodiments of the present invention. The IT2FLS 200 includes: a fuzzifier 202; a rule base 206; an inference engine 204; a type-Reducer 208; and a defuzzifier 210. A Type-1 Fuzzy Logic System (T1FLS) is similar to the system depicted in FIG. 2 except that there is no type-Reducer 208 in a T1FLS, and a T1FLS employs type-1 fuzzy sets in the input and output of the fuzzy logic system (FLS).

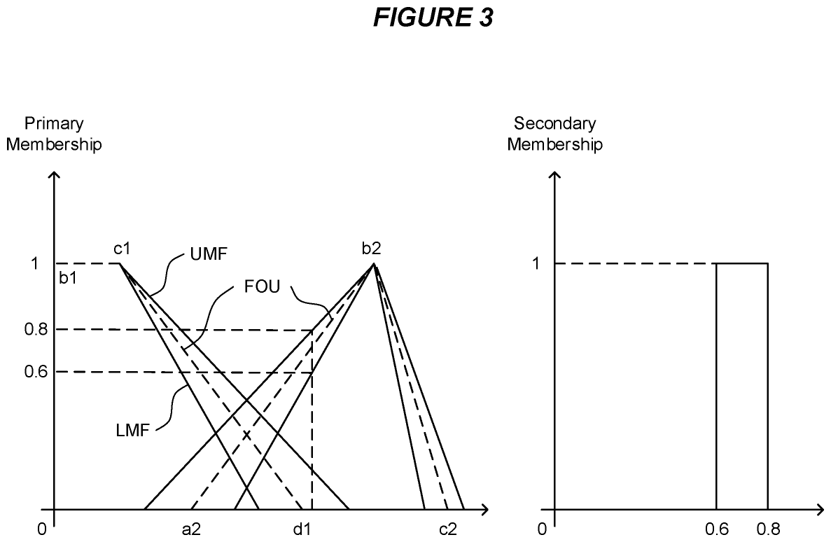

The IT2FLS 200 operates in the following way: crisp inputs in data are first fuzzified by the fuzzifier 202 into an input type-2 fuzzy set. A type-2 fuzzy set is characterized by a membership function. Herein we use interval type-2 fuzzy sets such as those depicted in FIG. 3 to represent inputs and/or outputs of the IT2FLS for simplicity. FIG. 3 illustrates membership for an Interval Type-2 Fuzzy Set according to an exemplary embodiment of the present invention. As depicted in FIG. 3, a membership for an Interval Type-2 fuzzy set is an interval (e.g. [0.6, 0.8]) rather than a crisp number as would be produced by a Type-1 fuzzy set.

Once inputs are fuzzified, the inference engine 204 activates a rule base 206 using the input type-2 fuzzy sets and produces output type-2 fuzzy sets. There may be no difference between the rule base of a type-1 FLS and a type-2 FLS except that fuzzy sets are interval type-2 fuzzy sets instead of type-1 fuzzy sets.

Subsequently, the output type-2 sets produced in the previous step are converted into a crisp number. There are two methods for doing this: in a first method, a two-step process is used where the output type-2 sets are converted into type-reduced interval type-1 sets followed by defuzzification of the type reduced sets; in a second method, a direct defuzzification process is introduced arising due to computational complexity of the first method. There are different types of type reduction and direct defuzzification such as those described by J. Mendel in “Uncertain Rule-Based Fuzzy Logic Systems: Introduction and New Directions” (Upper Saddle River, N.J.: Prentice Hall, 2001).

According to embodiments of the present invention, for a type-2 FLS, a Center of Sets type reduction is used as it has a reasonable computational complexity that lies between the computationally expensive centroid type reduction and simple height and modified height type reduction which have problems when only one rule fires (R. Chimatapu, H. Hagras, A. Starkey and G. Owusu, “Interval Type-2 Fuzzy Logic Based Stacked Autoencoder Deep Neural Network For Generating Explainable AI Models in Workforce Optimization,” 2018 IEEE International Conference on Fuzzy Systems (FUZZ-IEEE), Rio de Janeiro, 2018, pp. 1-8). After the type reduction, the type reduced sets are defuzzified by taking an average of the type reduced sets. For type-1 FLS, center of sets defuzzification is used.

The Big Bang Big Crunch (BB-BC) algorithm is a heuristic population-based evolutionary approach presented by Erol and Eksin (O. Erol and I. Eksin, “A new optimization method: big bang-big crunch,” Advances in Engineering Software, vol. 37, no. 2, pp. 106-111, 2006). Key advantages of the BB-BC are its low computational cost, ease of implementation and fast convergence. The algorithm is similar to a Genetic Algorithm with respect to creating an initial population randomly. The creation of the initial random population is called the Big Bang phase. The Big Bang phase is followed by a Big Crunch phase which is akin to a convergence operator that picks out one output from many inputs via a center of mass or minimum cost approach (B. Yao, H. Hagras, D. Alghazzawi, and M. Alhaddad, “A Big Bang-Big Crunch Optimization for a Type-2 Fuzzy Logic Based Human Behaviour Recognition System in Intelligent Environments,” in Systems, Man, and Cybernetics (SMC), 2013 IEEE International Conference on, 2013, pp. 2880-2886: IEEE). All subsequent Big Bang phases are randomly distributed around the output picked in the previous Big Crunch phase. The procedure of the BB-BC are as follows:
Step 1 (Big Bang Phase): Form an initial generation of N candidates randomly. Within the limits of the search space.
Step 2: Calculate the fitness function values of all the candidate solutions.
Step 3 (Big Crunch Phase): Big Crunch phase come as a convergence operator. Either the best-fit individual or the center of mass is chosen as the center point. The center of mass is calculated as:

$${x}_{c} = \frac{{\sum }_{i = 1}^{N} \frac{{x}_{i}}{{f}_{i}}}{{\sum }_{i = 1}^{N} \frac{1}{{f}_{i}}} \qquad ( 1 )$$

where x_{c} is the position of the center of mass, xᵢ is the position of the candidate, fᵢ is the cost function value of the i^{th} candidate, and N is the population size.
Step 4: Calculate new candidate solutions around the center of mass by adding or subtracting a normal random number whose values decrease as the iterations elapse. This can be formalized as:

$${x}_{n e w} = {x}_{c} + l r / k \qquad ( 2 )$$

where x_{c} is the position of the center of mass, l is the upper limit of the parameter, r is the random number and k is the iteration step. Then if the new point x_{new} is greater than the upper limit l then x_{new} is set to l. or if the new point x_{new} is smaller than the lower limit u then x_{new} is set to u.
Step 5: Check if stopping criteria are met if M iterations are completed stop else return to Step 2.

Optimization Method for the Multi Layer Fuzzy Logic System

Architecture of the Proposed Multi-Layer FLS

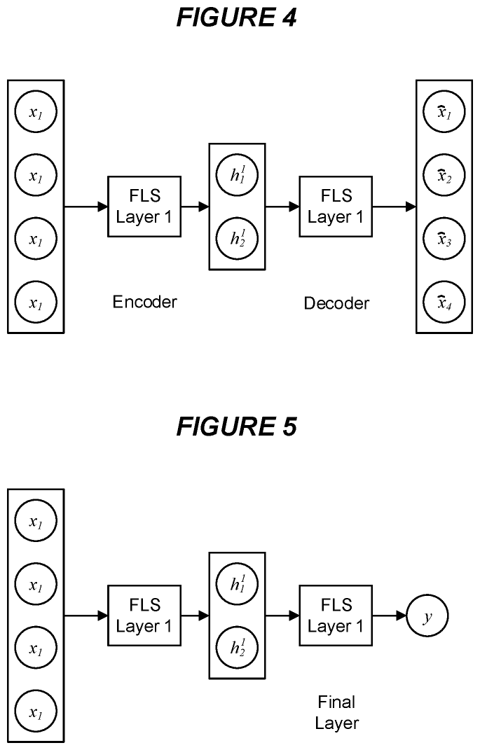

FIG. 4 illustrates an architecture of a Multi-Layer Fuzzy Logic System (M-FLS) in accordance with embodiments of the present invention. FIG. 4 shows two interval type-2 (IT2) Fuzzy Logic Systems where the output of the first FLS is the input for the second FLS. FIG. 4 illustrates a training structure of a first fuzzy-logic system in accordance with embodiments of the present invention. The structure of FIG. 4 is similar to an autoencoder when training to reproduce the input at the output.

FIG. 5 illustrates a Multi-Layer Fuzzy Logic System in accordance with embodiments of the present invention. In the arrangement of FIG. 5 a 2 layer system is provided with a first layer FLS for reducing a number of inputs by either combining features as rules or removing redundant inputs.

To optimize the Fuzzy Auto Encoder, the Membership Functions (MFs) and the rule base are optimized using a method similar to autoencoder training with some modifications. Firstly, the BB-BC algorithm is used in place of, for example, a gradient descent algorithm. Secondly, each auto encoder is trained in multiple steps instead of in a single step.

The steps followed for training the IT2 Fuzzy Autoencoder (FAE) is as follows:

1. Train a Type 1 FAE using BB-BC and the parameters of membership functions and rule base are encoded in the following format to create the particles of the BB-BC algorithm:

$${M}_{i} = {m}_{1}^{1} , … , {m}_{4}^{1} , {m}_{1}^{2} , … , {m}_{4}^{2} , … , {m}_{1}^{j} , … , {m}_{4}^{j} \qquad ( 3 )$$

where Mᵢ represents the membership functions for inputs and consequents, there are j membership functions per inputs and four points per MF representing the four points of a trapezoidal membership function.

$${R}_{l} = {r}_{1}^{1} , {r}_{2}^{1} , … , {r}_{a}^{1} , {c}_{1}^{1} , … , {c}_{b}^{1} \qquad ( 4 )$$

where Rₗ represents the lth rule of the FLS with a antecedents and c consequents per rule

$${N}_{1} = {M}_{1}^{e} , … , {M}_{i}^{e} , … , {M}_{i + k}^{e} , {R}_{l}^{e} , … , {R}_{l}^{e} , {M}_{1}^{d} , … , {M}_{g + h}^{d} , {R}_{1}^{d} , … , {R}_{l}^{d} \qquad ( 5 )$$

where Mᵢ^{e} represents the membership functions for the inputs of the encoder FLS along with the MF for the k consequents created using (3), Rₗ^{e} represents the rules of the encoder FLS with 1 rules and created using (4). Similarly, M_{g}^{d}, Rₗ^{d} represent the membership functions and rules of the decoder FLS.

2. In the second step a footprint of uncertainty is added to the membership functions of the inputs and the consequents and the system is trained using the BB-BC algorithm. The parameters for this step are encoded in the following format to create the particles of the BB-BC algorithm:

$${N}_{2} = {F}_{1}^{e} , … , {F}_{i}^{e} , … , {F}_{i + k}^{e} , {F}_{1}^{d} , … , {F}_{g}^{d} , … , {F}_{g + h}^{d} \qquad ( 6 )$$

where Fᵢ₊ₖ^{e} represents the Footprint of Uncertainty (FOU) for each of the i input and k consequent membership functions of the encoder FLS. Similarly, F_{g+h}^{d} represents the FOUs for the decoder FLS.

3. In the third step the rules of the IT2 FAE are retrained using BB-BC algorithm. The parameters for this step are represented as follows:

$${N}_{3} = {R}_{1}^{e} , … , {R}_{l}^{e} , {R}_{1}^{d} , … , {R}_{l}^{d} \qquad ( 7 )$$

Note: two default consequents can be added representing a maximum and minimum range of the output which improves the performance of the FLS.

The full ML FLS system including the final layer is trained starting from the FAE system trained using the method described above and removing the decoder layer of the FAE (per FIG. 5). Another FLS is used that will act as the final layer. The BB-BC algorithm is used to retrain both layers and parameters are encoded as follows:

$$P = {M}_{1}^{e} , {F}_{1}^{e} … , {M}_{i + k}^{e} , {F}_{i + K}^{e} {R}_{1}^{e} , … , {R}_{l}^{e} , {M}_{1}^{f} , {F}_{1}^{f} , … , {M}_{g + h}^{f} , {F}_{g + h}^{f} {R}_{1}^{f} , … , {R}_{l}^{f} \qquad ( 7 )$$

where Mᵢ^{e} represents MFs for inputs of the First FLS along with the MF for the k consequents created using (3); and F_{i+K}^{e} is the FOU for the MFs, Rₗ^{e} represents rules of the encoder FLS with 1 rules created using (4). Similarly, M_{g}^{f}, F_{g+h}^{f}, Rₗ^{f} represent the membership functions, FOU of MFs and rules of the second/final FLS.

Experiments were conducted using a predefined dataset. The IT2 Multi Layer FLS is compared with a sparse autoencoder (SAE) with a single neuron as a final layer trained using greedy layer-wise training (see, for example, Bengio et al.) The M-FLS system has 100 rules and 3 antecedents in the first layer and 10 consequents. The second layer also has 100 rules and 3 antecedents. Each input has 3 membership functions (Low, Mid and High) and there are 7 consequents at the output layer.

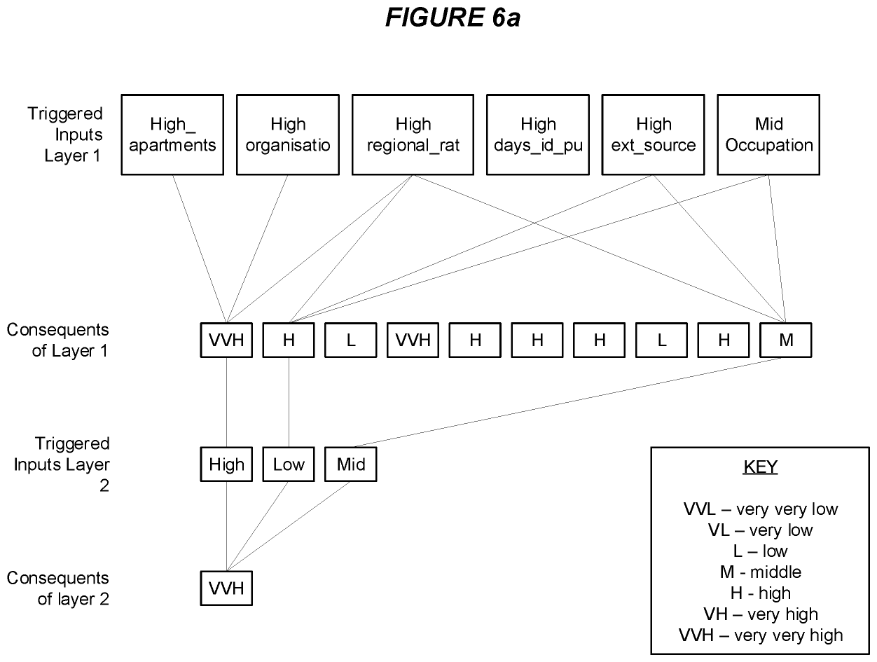

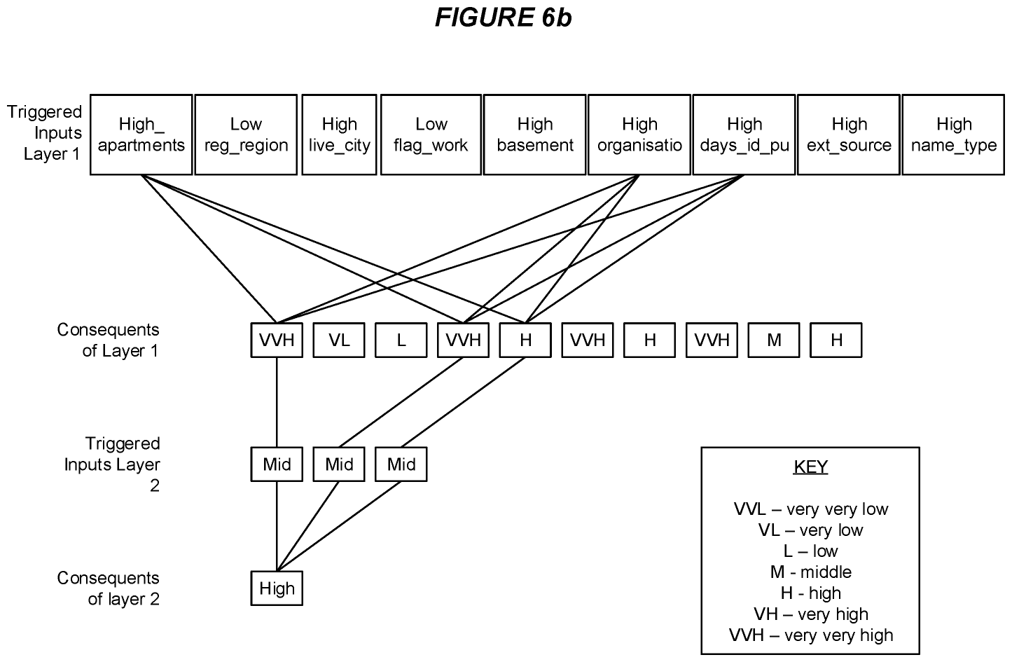

An exemplary visualization of rules triggered when input is provided to the system are depicted in FIGS. 6a and 6b. FIGS. 6a and 6b depict visualizations of triggered rules for an input in a Multi Layer Fuzzy Logic System according to embodiments of the present invention. To generate this visualization it is first determined which rules contribute the most to each of the consequents of the first layer. Then the rules contributing the most to the second layer of the M-FLS are determined. Using this information the visualization can depict rules that contribute to the final output of the M-FLS. In FIG. 6a only 2 rules contribute to the final output of the M-FLS. One of the rules triggered has the antecedents “High apartments”, “High Organization” and “High Days_ID_PU”. Another rule has the antecedents “High Region_Rating”, “High External_source”, and “Mid Occupation”. The visualization of FIG. 6a indicates that a combination “High Ext_Source”, “Mid Occupation” and “High Region_Rating” is important and it can be readily determined that the entity to which the data relates has a “very very high” association at the consequents of layer 2. FIG. 6b depicts a visualization in which different rules are triggered by the inputs. Notably, a Stacked Auto Encoder, for example, would not provide any clues about the reasoning behind the outputs it provides while the new proposed system gives us the reasoning quite clearly.

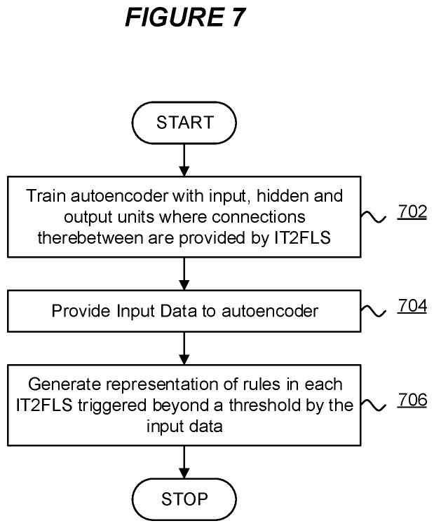

FIG. 7 is a flowchart of a method for machine learning according to embodiments of the present invention. Initially, at 702, an autoencoder is trained where the autoencoder has a set of input units, a set of output units and at least one set of hidden units. Connections between each of the sets of units are provided by way of interval type-2 fuzzy logic systems each including one or more rules. The fuzzy logic systems are trained using an optimization algorithm such as the BB-BC algorithm described above. At 704 input data is received at the input units of the autoencoder. At 706 the method generates a representation of rules in each of the interval type-2 fuzzy logic systems triggered beyond a threshold by input data provided to the input units so as to indicate the rules involved in generating an output at the output units in response to the data provided to the input units. Notably, the threshold could be a discrete predetermined threshold or a relative threshold based on an extent of triggering of each rule in the T2FLS.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for machine learning comprising:
training an autoencoder having a set of input units, a set of output units and at least one set of hidden units, wherein connections between the set of input units, the set of output units, and the at least one set of hidden units are provided by interval type-2 fuzzy logic systems each including one or more rules, and the interval type-2 fuzzy logic systems are trained using an optimization algorithm; and
generating a representation of rules in each of the interval type-2 fuzzy logic systems triggered beyond a threshold by input data provided to the set of input units so as to indicate rules involved in generating an output at the set of output units in response to the input data provided to the set of input units.

2. The method of claim 1, wherein the optimization algorithm is a Big-Bang Big-Crunch algorithm.

3. The method of claim 2, wherein each interval type-2 fuzzy logic system is generated based on a type-1 fuzzy logic system adapted to include a degree of uncertainty to a membership function of the type-1 fuzzy logic system.

4. The method of claim 3, wherein the type-1 fuzzy logic system is trained using the Big-Bang Big-Crunch optimization algorithm.

5. The method of claim 1, wherein the representation is rendered for display as an explanation of an output of the method.

6. A computer system comprising:
a processor and memory storing computer program code for machine learning by:
training an autoencoder having a set of input units, a set of output units and at least one set of hidden units, wherein connections between the set of input units, the set of output units, and the at least one set of hidden units are provided by interval type-2 fuzzy logic systems each including one or more rules, and the interval type-2 fuzzy logic systems are trained using an optimization algorithm; and
generating a representation of rules in each of the interval type-2 fuzzy logic systems triggered beyond a threshold by input data provided to the set of input units so as to indicate rules involved in generating an output at the set of output units in response to the input data provided to the set of input units.

7. A non-transitory computer-readable storage medium storing a computer program element comprising computer program code to, when loaded into a computer system and executed thereon, cause the computer system to perform the method as claimed in claim 1.
